(19) United States
(12) Patent Application Publication
(10) Pub. No.: US 2013/0274900 A1
(43) Pub. Date: Oct. 17, 2013

(54) ALTERNATIVE SYNCHRONIZATION CONNECTIONS BETWEEN REDUNDANT CONTROL DEVICES

(71) Applicant: PHOENIX CONTACT GMBH & CO. KG, (US)

(72) Inventors: Thorsten Uhde, Hameln (DE); Sascha Hollmann, Lemgo (DE); Andre Brand, Blomberg (DE); Henning Heutger, Bad Pyrmont (DE)

(21) Appl. No.: 13/737,036

(22) Filed: Jan. 9, 2013

(30) Foreign Application Priority Data
Feb. 10, 2012 (DE) 10 2012 002 494.0

(51) Int. Cl. G05B 11/01

(52) U.S. Cl. CPC G05B 11/01
USPC 700/82

(57) ABSTRACT

The invention relates to a redundant control system comprising an automation network with a first control device and a second control device. For data exchange, the first and the second control devices are in each case connected to the automation network via a network interface. For direct communication between each other, the first and the second control devices are connected to each other via a point-to-point connecting device. Furthermore, the first and the second control devices are designed to establish an alternative communication between each other via the automation network if the direct communication via the point-to-point connecting device is not available. The invention further relates to a method for operating such a redundant control system.

### CROSS-REFERENCE TO RELATED APPLICATIONS

German patent application DE 10 2012 002 494.0, filed on Feb. 10, 2012, is incorporated herein by reference.

### FIELD OF THE INVENTION

The present invention relates to a redundant control system comprising an automation network with a first and a second control device. The invention further relates to a method for operating a redundant control system.

### BACKGROUND OF THE INVENTION

For applications in automation technology which, for example, require high availability due to safety reasons, redundantly structured control systems are used which comprise a first control device and at least one second control device. Here, the first control device controls the process while the second control device runs in standby operation so as to be able, for example, to take control of the respective process in the event of failure of the first control device.

For this purpose, the program sequence is synchronized between the two redundant control devices via a synchronization connection so that the process can be continuously continued after the second control device has taken over the process. In order to ensure the consistent operation in the redundant control system, in addition to data of the process images, further information is exchanged so that each control device is informed about the functionality of the other control device. For this synchronization, usually, a point-to-point connection is established via adequate interfaces between two redundant controllers, which connection takes place through its own data line, for example, in the form of optical fibers.

The problem of such highly available redundant control systems is that the control devices are not able to differentiate a failure of the synchronization connection from a failure of the respective other control device since both of these failure possibilities lead to the same result that the information on functionality can no longer be exchanged.

In the event of a failure of the synchronization connection, the second control device provided for the backup operation could assume a failure of the first control device and could automatically take active control over the process to be controlled although the first control device is likewise still active. Both control devices could try to control the process at the same time, whereupon the process images, which are no longer synchronized, rapidly result in inconsistent conditions. In order to ensure a consistent operation in a redundant control system it is also required to avoid, e.g., simultaneous control through two control devices, which is referred to as double mastership.

### SUMMARY OF THE INVENTION

It is an object of the present invention to provide a solution by means of which the aforementioned problem of double mastership is avoided.

A redundant control system accordingly comprises an automation network with a first and a second control device. An automation network is to be understood, for example, as a PROFINET network to which a number of decentralized input and output devices can be connected through which a plant or a process can be monitored and controlled.

For data exchange, the first and the second control devices are in each case connected to the automation network via a network interface. Furthermore, for direct communication among themselves, the first and the second control devices are connected to each other via a point-to-point connecting device.

A connecting device can be understood as a line link which can be implemented, for example, as an optical fiber. The line link can be formed as a full-duplex connection.

It is provided according to the invention that the first and the second control devices are designed to establish an alternative communication between each other via the automation network if direct communication via the point-to-point connecting device is not available.

The present invention thus makes a redundant point-to-point communication possible without the need of an additional connecting device between the two redundant control devices.

In a particularly advantageous embodiment of the invention, the alternative communication can comprise at least a partial synchronization between the first and the second control devices. Synchronizing the process images in the two redundant controllers can be maintained at least with limited transmission bandwidth via the automation network.

The first or the second control device can be selected as the primary control, wherein the other control device is selected as the backup controller.

The first and the second control devices are preferably designed to autonomously negotiate among each other the selection as the primary controller and as the backup controller.

Preferably, the backup controller is designed to cyclically check the direct communication with the primary controller. This cyclical check can be performed via the automation network for a communication established through the point-to-point connecting device as well as for the alternative communication path.

Also, the backup controller can be designed in a particularly preferred manner to assume the tasks of the primary controller after the alternative communication via the automation network has been failed.

The object of the invention is further achieved by providing a method for operating a control system according to the invention.

A control system comprises according to the method a first and a second control device within an automation network, wherein for carrying out said method, one of the two control devices has been selected as the primary controller and the other one as the backup controller.

The method for operating an above-described redundant control system is characterized by the following steps:
a) cyclically checking by the backup controller if there is a direct communication to the primary controller via a point-to-point connecting device;
b) initiating by the backup controller an alternative communication to the primary controller via the automation network, provided that there is no direct communication via the point-to-point connecting device;
c) checking by the primary controller if an alternative communication has been established successfully;
d) assuming the tasks of the primary controller by the backup controller, provided that the alternative communication has not been established successfully.

With the direct communication, synchronizing between the primary controller and the secondary controller can be carried out.

Provided that there is an alternative communication, it is at least partially possible via the automation network to carry out synchronization between the primary controller and the secondary controller as part of the alternative communication.

During the at least partial synchronization it can be checked if the alternative communication via the automation network is still established.

The tasks of the primary control can be assumed by the backup controller, provided that the alternative communication has been interrupted.

Advantageously, a first error message can be generated by the backup controller if there is no direct communication via the point-to-point communication device.

Furthermore, a second error message can be generated by the backup controller if there is no alternative communication via the automation network.

### BRIEF DESCRIPTION OF THE DRAWINGS

The invention is described in detail hereinafter by means of exemplary embodiments with reference to the two accompanying drawings. In the figures:

FIG. 1 shows a redundant control system according to the present invention,

FIG. 2 shows a flow diagram of a method for operating a redundant control system.

### DETAILED DESCRIPTION

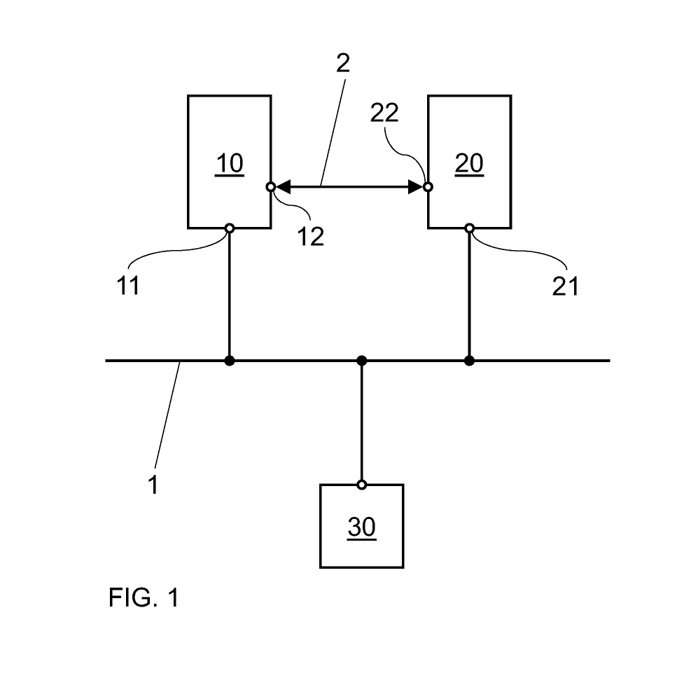

FIG. 1 shows a redundant control system according to the invention. An automation network is implemented, for example, as a PROFINET network 1. A first control device 10 and a second control device 20 are in each case connected to the PROFINET network via a PROFINET IO controller interface 11 and 21, respectively. Furthermore, connected to the network are a number of input and output devices (I/O devices) of which an I/O device 30 is illustrated as an example. The control devices 10 and 20 are provided for redundantly controlling a plant or a process.

For synchronizing the two control devices 10 and 20, an Ethernet-based communication is used which typically can be implemented as point-to-point connecting device 2 between the two synchronization interfaces 12 and 21, for example, by using fiber optic technology. Alternatively, the connecting device can also be implemented as an electrical connection.

The two redundant control devices 10 and 20 can be configured as primary controller PRIMARY and as backup controller BACKUP. The allocation PRIMARY and BACKUP can change whereas an allocation as first and second control device 10 and 20, respectively, remains constant over the run time. In the case of an existing synchronization connection, the roles as a primary controller and as a backup controller can be directly negotiated between the two control devices.

Communication to the I/O devices 30 or to further non-illustrated subscribers in the PROFINET network 1 takes place via the Ethernet-based PROFINET protocol. Here, in normal operation, each of the two control devices 10 and 20 has established a communication connection to the I/O device or to each of the further subscribers.

The synchronization of the actual user programs, i.e., the adjustment of the process images and/or all control system states of the two control devices is carried out via the connecting device 2. Furthermore, a so-called link monitoring protocol is used for exchanging information on functionality between the two control devices 10 and 20.

On this basis it is ensured that the controllers operate in defined states with respect to each other and are able to adjust automatically for this purpose.

Through a suitable configuration of the PROFINET IO controller interfaces 11 and 21 it can be ensured that both control devices 10 and 20 are in the same subnet of the PROFINET network. Thus, a direct Ethernet communication between the two PROFINET IO controller interfaces is also possible.

Since the communication for the synchronization and also for the data exchange with the I/O device 30 takes place via an Ethernet-based connection, a redundant connection for the synchronization can be provided by the redundant control system illustrated in FIG. 1 without the need of additional hardware.

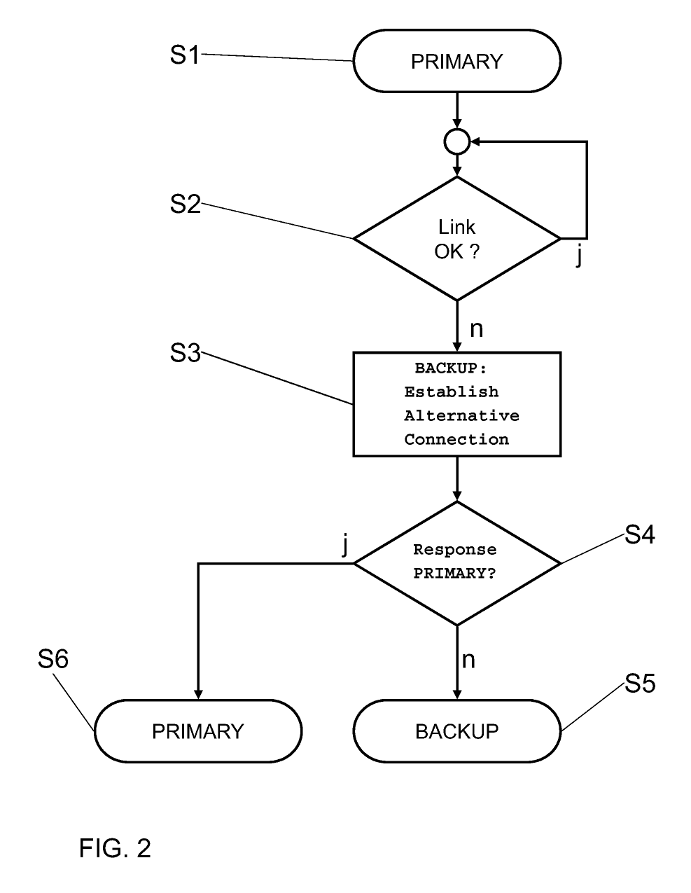

In the flow diagram according to FIG. 2, a method for operating a control system according to the invention is illustrated in an example.

As the step S1 in FIG. 2 illustrates, the control device selected as the primary controller PRIMARY activates in a normal operation the I/O device or the further subscribers in the PROFINET network. A plant or a process is controlled by the primary controller PRIMARY while the backup controller BACKUP only passively processes the process data of the subscribers. The system states or process images of both control devices are continuously synchronized.

According to step 2, the backup control BACKUP checks cyclically if there is a synchronization connection to the primary controller PRIMARY. If it is detected by means of the link monitoring protocol that data is no longer exchanged via the synchronization interface 12 or 22 or via the connecting device 2, the backup controller BACKUP tries according to the step designated as S3 to establish a connection via the PROFINET network 1 to the control device selected as primary controller PRIMARY.

Establishing the alternative connection to the primary control PRIMARY is monitored according to step 4 by the backup controller BACKUP, for example, in that the backup controller waits for a response within a defined time window.

If it is not possible to establish an alternative connection, an actual failure of the primary control PRIMARY has occurred and, according to step S5, the control device selected as the backup controller BACKUP takes over the control of the process or the plant.

However, if a communication connection to the control device selected as the primary controller PRIMARY can be established, only a failure of the synchronization connection has occurred. In this case, according to the step 6, no switch of the control role from the primary to the backup controller takes place; an undesirable double mastership is effectively prevented.

The backup controller can effectively differentiate between a failure of the primary controller PRIMARY and a failure of the synchronization connection so that a respective failure can be signalized. A corresponding error message puts the user in the position to be able to resolve the problem without the need to interrupt the running process.

Moreover, it is also possible to continue the synchronization of the user program or the process image via the PROFINET network. Thereby, not only the continuation of the control of a process or a plant is ensured, but the redundant operation can also be maintained.

However, synchronizing can usually take place only to a limited extent since in addition to the synchronization, the communication with the I/O device 30 and the further subscribers also takes place via the PROFINET network. Thus, the bandwidth available for synchronization is smaller than in a normal operation in which the first and the second control devices 10 and 20 are synchronized via the point-to-point connecting device 2.

What is claimed is:

1. A redundant control system comprising:
an automation network with a first control device and a second control device;
wherein for data exchange, the first and the second control devices are in each case connected to the automation network via a network interface;
wherein for direct communication among each other, the first and the second control devices are connected to each other via a point-to-point connecting device; and
wherein the first and the second control devices are designed to establish an alternative communication between each other via the automation network if direct communication via the point-to-point connecting device is not available.

2. The redundant control system according to claim 1, wherein the direct communication comprises synchronization between the first and the second control devices.

3. The redundant control system according to claim 1, wherein the alternative communication comprises at least partial synchronization between the first and the second control devices.

4. The redundant control system according to claim 1, wherein the first or the second control device is selected as the primary controller, wherein the other control device is selected as the backup controller.

5. The redundant control system according to claim 1, wherein the first and the second control devices are designed to autonomously negotiate among each other the selection as the primary controller and as the backup controller.

6. The redundant control system according to any-one-of claim 4, wherein the backup controller is designed to cyclically check the direct communication with the primary controller.

7. The redundant control system according to claim 6, wherein the backup controller is designed to assume the tasks of the primary controller if the alternative communication via the automation network is not available.

8. A method for operating a redundant control system with a first and a second control device in an automation network, wherein one of the two control devices has been selected as the primary controller and the other one as the backup controller, according to claim 1, wherein the method comprises:
a) cyclically checking by the backup controller if there is a direct communication to the primary controller via a point-to-point connecting device;
b) initiating by the backup controller an alternative communication to the primary controller via the automation network, provided that there is no direct communication via the point-to-point connecting device;
c) checking by the primary controller if an alternative communication has been established successfully; and
d) assuming the tasks of the primary controller by the backup controller, provided that the alternative communication has not been established successfully.

9. The method according to claim 8, wherein, via the direct communication, synchronizing between the primary controller and the secondary controller is carried out.

10. The method according to claim 8, wherein, provided that there is an alternative communication, synchronizing between the primary controller and the secondary controller as part of the alternative communication is carried out via the automation network.

11. The method according to claim 10, wherein, during the at least partial synchronization, it is checked if the alternative communication via the automation network is still established.

12. The method according to claim 11, wherein the tasks of the primary controller are taken over by the backup controller, provided that the alternative communication has been interrupted.

13. The method according to claim 8, wherein a first error message is generated by the backup controller if there is no direct communication via the point-to-point connecting device.

14. The method according to claim 8, wherein a second error message is generated by the backup controller if there is no alternative communication via the automation network.
